(19) United States
(12) Patent Application Publication
(10) Pub. No.: US 2010/0161378 A1
(43) Pub. Date: Jun. 24, 2010

(54) System and Method for Retargeting Advertisements Based on Previously Captured Relevance Data

(76) Inventors: Vanja Josifovski, Los Gatos, CA (US); George Hu, San Jose, CA (US); Jianchang (JC) Mao, San Jose, CA (US); Majid Mohazzab, Saratoga, CA (US); Andrei Broder, Menlo Park, CA (US)

Correspondence Address: STATTLER - SUH PC, 60 SOUTH MARKET STREET, SUITE 480, SAN JOSE, CA, 95113, US

(21) Appl. No.: 12/342,566

(22) Filed: Dec. 23, 2008

(51) Int. Cl. G06F 17/30; G06Q 30/00

(52) U.S. Cl. 705/10; 705/14.41; 705/14.73

(57) ABSTRACT

Methods for selecting one or more advertisements based on previously captured relevance data to serve to a client system requesting a primary webpage is provided. The client displays a referring webpage having a hyperlink to the primary webpage. Upon selection of the hyperlink, the client sends a request to a content server storing the primary webpage. The content server classifies the primary webpage for content and retrieves persistent relevance information, possibly including a referrer of the primary webpage comprising a URL address of the referring webpage, a listing of other recently visited webpages, a listing of any bid phrases from previously displayed advertisements, and a listing of recent click data. The content server sends the primary webpage to the client, which includes an advertisement server request. The transaction between the content server and the advertisement server includes persistence relevance information to select advertisements to serve to the client.

### FIELD OF THE INVENTION

The present invention is directed towards retargeting advertisements based on previously captured relevance data.

### BACKGROUND OF THE INVENTION

When a user makes a request for a webpage (base content) to a server via a network, additional content is also typically sent to the user along with the base content. The user can be a human user interacting with a user interface of a computer that transmits the request for base content. Base content might include a variety of content and is typically provided and presented to a user as a published webpage. For example, base content presented as a webpage may include published information, such as articles about politics, business, sports, movies, weather, finance, health, consumer goods, etc. Additional content might include content that is relevant/related to the base content. For example, relevant additional content may include advertisements for products or services that are related to the base content. Base content providers receive revenue from advertisers who wish to have their advertisements displayed to users and typically pay a particular amount each time a user clicks on one of their advertisements. Using the techniques for re-presenting advertisements, impressions and click-through rates might be increased, and hence revenue might be increased.

Other features and advantages of the present invention will be apparent from the accompanying drawings, and from the detailed description that follows below.

### SUMMARY OF THE INVENTION

A method and apparatus for selecting advertisements to serve to a user/client system requesting a webpage is provided. As a user/client traverses through a plurality of webpages, relevance data related to advertisements is captured for subsequent use in re-serving relevant advertisement to a user/client system. Exemplary implementations include techniques for selecting advertisements for presenting on a first webpage, capturing relevance data including capturing user click-through and other user actions, and then selecting advertisements, using said relevance data for presenting on a second webpage.

### BRIEF DESCRIPTION OF THE DRAWINGS

The novel features of the invention are set forth in the appended claims. However, for purpose of explanation, several embodiments of the invention are set forth in the following figures.

FIG. 1 shows a network environment in which some embodiments operate.

FIG. 2 shows a conceptual diagram of a revenue-optimization system.

FIG. 3 is a block diagram of an exemplary interface for displaying base content and additional content according to some embodiments;

FIG. 4A shows an exemplary referring webpage;

FIG. 4B shows an exemplary primary webpage having a metadata section;

FIG. 5A shows an exemplary search query entry webpage having a search query interface;

FIG. 5B shows an exemplary referring webpage having a URL address containing attached search query terms;

FIG. 5C shows an exemplary primary webpage having a metadata section;

FIGS. 6A-B are flowcharts of a method for selecting one or more advertisements to serve to a client system requesting a webpage;

FIGS. 6C is a flowchart of a method for capturing and filtering webpage terms and bid phrases;

FIG. 6D is a flowchart of a method including a decision for retrieving webpage terms and bid phrases;

FIG. 6E is a diagram of possible time-based weighting and expiration for webpage terms;

FIG. 6F is a diagram of possible time-based weighting and expiration for webpage terms including heuristics for refreshing weights;

FIG. 6G is an abstraction of a data structure for managing time-based weighting and expiration for webpage terms;

FIGS. 7A-B are flowcharts of a method for selecting one or more advertisements to serve to a client system performing a search query and requesting a webpage;

FIG. 7C is a flowchart of a method for capturing and filtering referrer webpage terms, query information, and click data;

FIG. 7D is a flowchart of a method including a decision for retrieving referrer webpage terms, query information, and click data;

FIG. 8 shows a conceptual diagram of the operation of the advertisement selection module in selecting advertisements to serve; and

FIG. 9 shows a conceptual diagram of an alternative embodiment of the advertisement selection module in selecting advertisements to serve.

FIG. 10 is a flowchart of one embodiment of a method for selecting advertisements to serve based on previously captured relevance data.

FIG. 11 is a diagrammatic representation of a machine in the exemplary form of a computer system, within which a set of instructions may be executed.

FIG. 12 is a diagrammatic representation of several computer systems in the exemplary form of a client server network, within which environment a communication protocol may be executed.

### DETAILED DESCRIPTION

In the following description, numerous details are set forth for purpose of explanation. However, one of ordinary skill in the art will realize that the invention may be practiced without the use of these specific details. In other instances, well-known structures and devices are shown in block diagram form in order not to obscure the description of the invention with unnecessary detail.

A variety of methods may be employed to determine which advertisements to display to a user in expectation of notice and click-through. In many cases, however, some advertisements are displayed to a user but are not noticed because the advertisements are not positioned prominently on the page, or because of lack of time spent on the page, or because of other reasons. In such cases, since the original impression of the advertisement was deemed relevant to the user (even if unnoticed), the unnoticed advertisements might be reused (re-displayed) in subsequent page impressions that are presented within some time limit related to relevance persistence. Determining which advertisements to reuse and re-serve to a user, and determining a period over which aspects of relevance are persistent (and for how long), is important in improving the user experience of a webpage and in maximizing advertiser revenue. As described below, Section I discusses general terms and a network environment in which some embodiments operate. Section II discusses methods and apparatus for retargeting advertisements based on previously captured relevance data.

### Section 1: General Terms and Network Environment

A client system (operated by a user) may display, e.g., via a web browser program, an initial webpage (referred to as the referring webpage) that shows one or more hyperlinks to one or more landing webpages. Upon selection of one of the hyperlinks (referred to as the primary hyperlink) by the user, the client system sends a request (e.g., a hypertext transfer protocol (HTTP) request) to a base content server that stores and maintains the selected landing webpage (referred to as the primary webpage) of the selected hyperlink. Typically, the client system (e.g., via the web browser program) includes a “referrer” of the primary webpage as a uniform resource locator (URL) address of the prior referring webpage from which the primary webpage was retrieved) in the request for the primary webpage sent to the base content server.

Upon receiving the request for the primary webpage (the request including the referrer of the primary webpage), the base content server retrieves and sends the primary webpage to the client system, the primary webpage comprising base content requested by the user. In some embodiments, the primary webpage also includes data regarding the referrer of the primary webpage (e.g., attached to the metadata field of the primary webpage). In further embodiments, the primary webpage further includes an embedded advertisement request mechanism (e.g., iframe mechanism, JavaScript code, etc.) configured to make an advertisement request (e.g., HTTP request) to an additional content server (that stores a plurality of advertisements) to send one or more advertisements to serve with the primary webpage. In some embodiments, the embedded advertisement request mechanism is configured to read the data regarding the referrer of the primary webpage (e.g., read the referrer data from the metadata field of the primary webpage) and include the referrer data in the advertisement request to the additional content server. In other embodiments, the embedded advertisement request mechanism is configured to extract one or more terms from the referrer data and include the one or more extracted terms in the advertisement request to the additional content server. The advertisement request mechanism embedded in the primary webpage may be configured to perform these operations, for example, upon the primary webpage being received and displayed by the client system.

After receiving the advertisement request that includes referrer data of the primary webpage and/or terms extracted from the referrer data, the additional content server uses the referrer data to select one or more advertisements to serve with the primary webpage. As such, data regarding the referrer of a primary webpage (e.g., an URL address of the prior referring webpage from which the primary webpage was retrieved) is used to select one or more advertisements to serve with the primary webpage. In some embodiments, the content of the primary webpage is also used to select the one or more advertisements to serve with the primary webpage. The additional content server then sends the one or more selected advertisements to the client system for display to the user.

In some embodiments, a user/client system may submit a search query to a search engine server. In these embodiments, the client system may display an initial webpage (referred to as the query entry webpage) and receive, from the user, a search query comprising one or more terms (e.g., via a user interface). The client system may submit the search query to a search engine server (e.g., via a network) that, in response, returns a search results webpage (referred to as the referring webpage) showing search results (e.g., in the form of one or more hyperlinks to one or more landing webpages). When creating the search results webpage, the search engine server typically attaches the search query terms to the uniform resource locator (URL) address of the search results webpage. As known in the art, a search query submitted by a user and attached to a URL address of a search results webpage is sometimes referred to as a referral string (since it is this particular search query that refers the user to a particular landing webpage selected by the user and is used to retrieve the particular landing webpage).

The client system then receives, from the user, a selection of one of the hyperlinks (referred to as the primary hyperlink) in the search results. Upon receiving the selection the primary hyperlink, the client system sends a request (e.g., HTTP request) to a base content server that stores and maintains the selected landing webpage (the primary webpage) of the selected hyperlink. Typically, the client system includes a referrer of the primary webpage (e.g., an URL address of the prior referring webpage from which the primary webpage was retrieved) in the request for the primary webpage sent to the base content server. Since the search query is attached to the URL address of the search results webpage (which is the prior referring webpage) by the search engine server, the referrer will contain the terms of the search query and be included in the request for the primary webpage sent to the base content server.

Upon receiving the request for the primary webpage (the request including the referrer of the primary webpage and hence includes the search query), the base content server retrieves and sends the primary webpage to the client system, the primary webpage comprising base content requested by the user. In some embodiments, the primary webpage also includes data regarding the referrer of the primary webpage (and hence includes data regarding the search query terms). The primary webpage may further include an embedded advertisement request mechanism configured to make an advertisement request to an additional content server to send one or more advertisements to serve with the primary webpage. In some embodiments, the embedded advertisement request mechanism is configured to read the data regarding the referrer of the primary webpage (and hence to read data regarding the search query) and include the referrer data (and hence include search query data) in the advertisement request to the additional content server. In other embodiments, the embedded advertisement request mechanism is configured to extract one or more terms from the referrer data (and hence to extract one or more terms from the search query) and include the one or more extracted terms in the advertisement request to the additional content server.

After receiving the advertisement request that includes referrer data (and hence search query data) of the primary webpage and/or terms extracted from the referrer data, the additional content server uses the referrer data to select one or more advertisements to serve with the primary webpage. As such, data regarding the referrer of a primary webpage (and hence data regarding the search query) is used to select one or more advertisements to serve with the primary webpage. Of course, in normal usage, a user might browse any number of pages, and/or click any number of links or advertisements, and/or perform additional searches, and during such course, various characteristics of the browsing activities can be captured and stored for some duration, thus creating a record comprising persistent relevance data. In the contexts herein, the term ‘capture’ might mean merely to store in some form (encoded or unencoded) in some memory location, or it might refer to place into the data fields of a transmitted packet of information, or it might mean to store in some volatile or non-volatile memory device.

In some embodiments, certain content of the primary webpage is also used to select the one or more advertisements to serve with the primary webpage. However, in situations where the primary webpage is deemed to have low content (or the content that is deemed analyzable by a server is low), the captured and stored browsing activities can be used to impute relevance to the primary webpage. In such cases, the content server and/or the additional content server might use the imputed relevance to select one or more relevant advertisements. The additional content server then sends the one or more selected advertisements to the client system for display to the user.

By selecting advertisements to serve with a webpage using information derived from the persistent relevance data, an additional resource of information may be used to select the advertisements. The referrer address of the webpage contains useful information in selecting advertisements for a user since it provides information regarding a just prior webpage that the user visited. Yet another resource of information is present in previously presented advertisements in that those advertisements, and/or their content, and/or any dynamic configuration metadata, and/or any corresponding bid phrases, are also a source of useful information in selecting advertisements for a user. In the particular condition where a search query is also submitted by a user, the referrer address of the webpage may contain especially useful information since the search query reflects the intent of the user. By considering persistent relevance data, the rate of impressions as well as the rate of selections/clicks on advertisements by users may increase and advertisement revenue may be optimized.

As used herein, base content is requested by a user that may include a variety of content (e.g., news articles, emails, chat-rooms, etc.) having a variety of forms including text, images, video, audio, animation, program code, data structures, hyperlinks, etc. The base content is typically presented as a webpage and may be formatted according to the Hypertext Markup Language (HTML), the Extensible Markup Language (XML), Standard Generalized Markup Language (SGML), or any other language. As used herein, a primary webpage is requested by the user. Methods and apparatus described herein are used for selecting advertisements to serve to the user based on criteria selected from one or more sources including information available from the primary webpage, information available from a referrer to the primary webpage, and/or user sequence/activity data captured during traversal between any referrer webpage to the primary webpage.

As used herein, additional content comprises one or more advertisements that are sent to the user that requests the primary webpage (base content) that are determined to be relevant to the primary webpage and/or of interest to the user. An advertisement may comprise or include a hyperlink (e.g., sponsored link, integrated link, inside link, or the like). An advertisement may include a similar variety of content and form as the base content described above; in fact, specific content in an advertisement might be configured dynamically, just at the moment of the impression, where such configuration can be based on criteria selected from one or more sources including information available from the primary webpage, information available from a referrer to the primary webpage, and/or user sequence/activity data captured during traversal between any referrer webpage to the primary webpage.

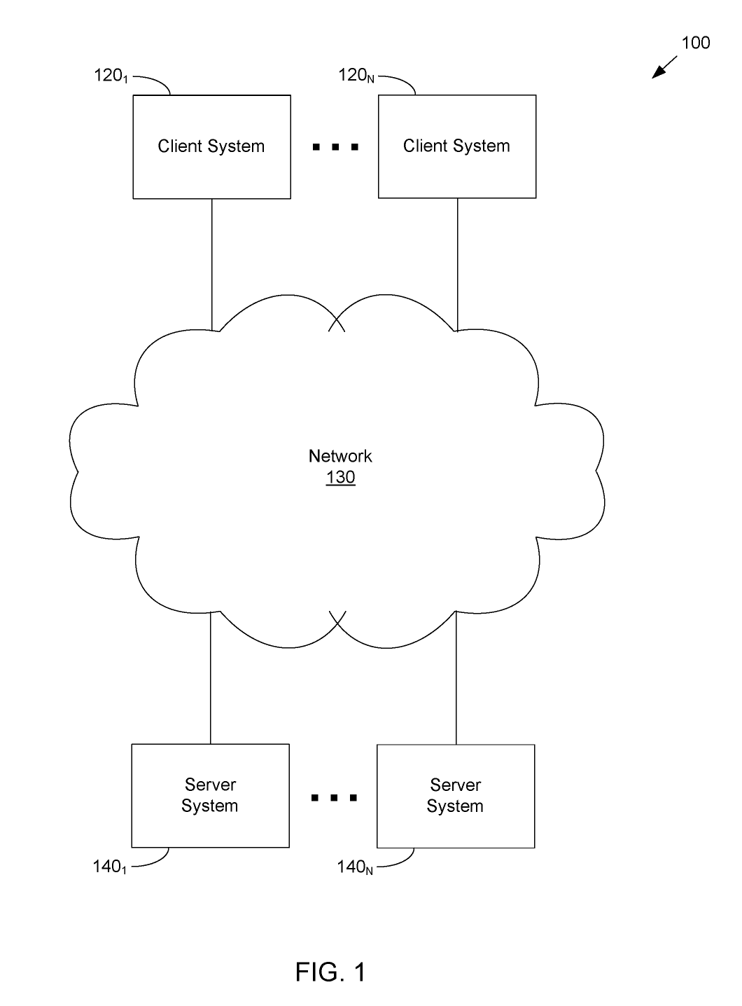

FIG. 1 shows a network environment 100 in which some embodiments operate. The network environment 100 includes client systems 120₁ to 120_{N} and server systems 140₁ to 140_{N} coupled to a network 130 (such as the Internet or an intranet, an extranet, a virtual private network, a non-TCP/IP based network, any LAN or WAN, or the like). In some embodiments, the client system 120 and/or system servers 140₁ to 140_{N} are configured to perform the methods described herein. The methods of some embodiments may be implemented in software or hardware configured to optimize the selection of additional content to be displayed to a user.

A server system 140₁ may include a single server computer or a plurality of server computers 140₁-140_{N} for providing a variety of network services (e.g., performing search queries, providing base content, capturing and filtering webpage information and/or user activity data, and/or providing advertisements). Each client system 120 is configured to communicate with a server system 140. The client system 120 may include a desktop personal computer, workstation, laptop, PDA, cell phone, any wireless application protocol (WAP) enabled device, or any other device capable of communicating directly or indirectly to a network. The client system 120 typically runs a web browsing program (such as Microsoft's Internet Explorer™ browser, Netscape's Navigator™ browser, Mozilla™ browser, Opera™ browser, a WAP-enabled browser in the case of a cell phone, PDA or other wireless device, or the like) allowing a user of the client system 120 to perform search queries and request and receive content from server systems 140₁ to 140_{N} over network 130. The client system 120 typically includes one or more user interface devices (such as a keyboard, a mouse, a roller ball, a touch screen, a pen or the like) for interacting with a graphical user interface (GUI) of the web browser on a display (e.g., monitor screen, LCD display, etc.).

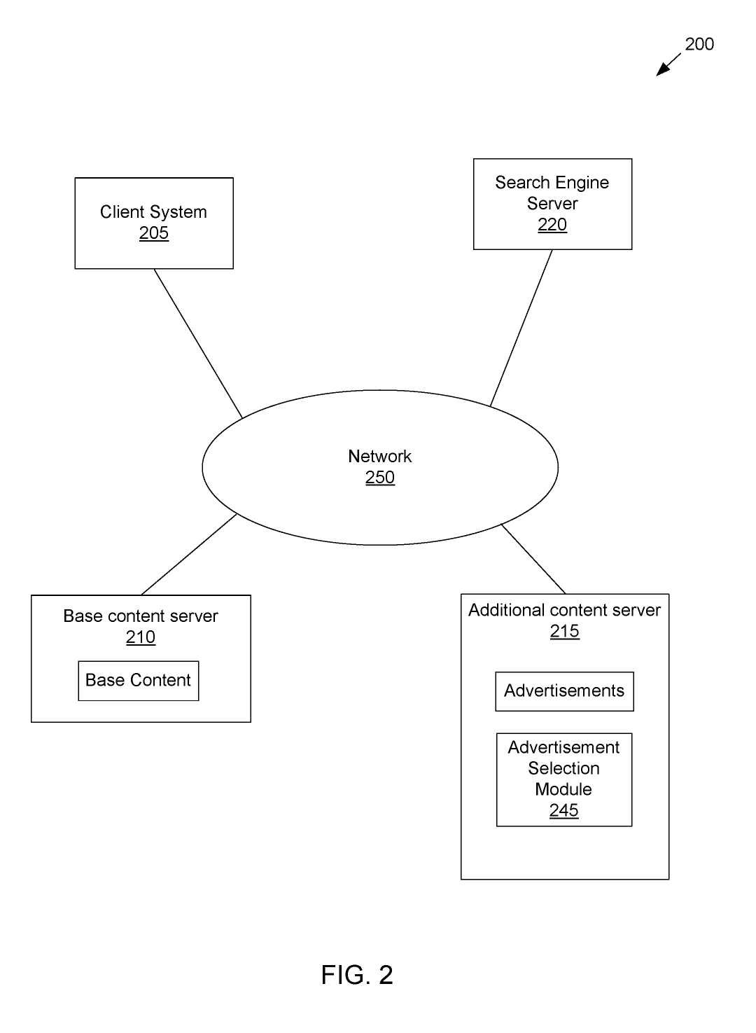

FIG. 2 shows a conceptual diagram of a revenue-optimization system 200. The revenue-optimization system 200 may include zero or more client system 205, zero or more base content servers (publishers) 210, zero or more additional content servers 215, or zero or more search engine servers 220, each connected to a network 250 (e.g., Internet). The revenue-optimization system 200 is configured to select additional content (advertisements) to be sent to a user/client system that maximizes expected revenue generation for base content providers, network service providers, and/or advertisers.

The client system 205 is configured to request and receive content (e.g., in the form of webpages) from a base content server 210 and/or additional content server 215, where such content may include base content (a requested webpage) and/or additional content (advertisements). In some embodiments, the client system 205 (operated by a user) may display an initial webpage (referred to as the referring webpage) that shows one or more objects where at least one such object contains one or more hyperlinks to one or more landing webpages. Upon selection of one of the hyperlinks (referred to as the primary hyperlink) by the user, the client system sends a request (e.g., HTTP request) to the base content server 210 that stores and maintains the selected landing webpage (the primary webpage) of the selected hyperlink. The request (for the primary webpage) sent to the base content server 210 includes a referrer of the primary webpage (e.g., an URL address of the prior referring webpage from which the primary webpage was retrieved).

The client system 205 may be further configured to request search queries and receive search results from the search engine server 220. In some embodiments, the client system 205 may display an initial query entry webpage where a user inputs (e.g., via a user interface) a search query (comprising one or more search query terms). The client system 205 then receives (from the search engine server 220) and displays a search results webpage (the referring webpage), the search results webpage might have a URL address that contains terms of the search query, or the search results webpage might have an associated repository that contains terms and/or other characteristics of the search query. The search results webpage shows search results comprising one or more hyperlinks to one or more landing webpages. Upon selection of one of the hyperlinks (the primary hyperlink) by the user, the client system sends a request to the base content server 210 that stores and maintains the selected landing webpage (the primary webpage) of the selected hyperlink. The request (for the primary webpage) sent to the base content server 210 includes a referrer of the primary webpage (e.g., an URL address of the prior referring/search results webpage from which the primary webpage was retrieved).

After sending the request for the primary webpage to the base content server 210, the client system 205 may also be configured receive the primary webpage and additional content (advertisements) related to the primary webpage. The client system 205 is further configured to display the received base content and/or additional content to a user and receive selections of advertisements from the user (e.g., through a user interface). Of course certain user activity might be captured either by the client system 205, or by the base content server 210, or by the additional content server 215, or by the search engine server 220, and/or any combination of these. The captured user activity (in whole or in part) can be retrieved by any of the aforementioned systems or servers.

The search engine server 220 is configured to receive a search query from the client system 205, perform the search query (comprising one or more terms), attach the search query terms to a search results webpage (for example, within the uniform resource locator address), and serve the search results webpage to the client system 205, the search results webpage typically comprising search results in the form of one or more hyperlinks to one or more landing webpages.

The base content server (publisher) 210 stores a plurality of webpages (base content) and is configured to receive requests (e.g., HTTP requests) for webpages and retrieve and send requested webpages. The additional content server 215 stores a plurality of advertisements (additional content) from various advertisers. In some embodiments, an advertisement is associated with one or more keywords that represent and describe the advertisement. In other embodiments, an advertisement is associated with one or more bidded phrases, a bidded phrase comprising one or more keywords/terms. In still other embodiments, an advertisement is structured so as to be dynamically configured based upon one or more bidded phrases and/or one or more keywords/terms. The additional content server 215 comprises an advertisement selection module 245 that is used to determine which advertisements from the additional content server 215 to serve to the user/client system requesting the primary webpage. As further described herein, the advertisement selection module 245 might implement techniques for retargeting advertisements based on previously captured relevance data

In some embodiments, the advertisement selection module 245 receives a referrer of a primary webpage (or receives terms extracted from the referrer of the primary webpage), where the referrer may comprise an URL address of a prior referring webpage from which the primary webpage was retrieved. In some embodiments, the referrer of the primary webpage comprises one or more search query terms from a user requesting the primary webpage. The advertisement selection module 245 may use the referrer (or query or other terms extracted from the referrer) and/or bidded phrases, and/or other captured relevance data or activity to determine one or more advertisements to serve to the user/client system 205 requesting the primary webpage. In further embodiments, the advertisement selection module 245 may also use content data of the primary webpage in selecting the one or more advertisements to serve. In still further embodiments, the advertisement selection module 245 may also use any captured data or activity (e.g. clicks or activity captured during the traversal from previously visited webpages to the primary webpage) in selecting the one or more advertisements to serve.

In determining which advertisements to serve to the user/client system 205, the advertisement selection module 245 may use the referrer and/or content information to determine a list of one or more primary webpage keywords (indicating topics/subject areas) that are related to the primary webpage or that may be of interest to the user. In some embodiments, the advertisement selection module 245 selects for serving those advertisements in the additional content server 215 having an associated keyword that matches one or more of the primary webpage keywords. As used herein, a keyword can comprise a single term (e.g., “cars,” “television,” etc.) or a plurality of terms (e.g., “car dealer,” “New York City,” etc.). For example, the set of primary webpage keywords may comprise “automobile,” “sports car,” “sports car accessories,” etc. A particular advertisement may be represented by the keywords “sports car,” “high performance automobile,” etc. Since the advertisement keyword “sports car” matches the primary webpage keyword “sports car” (i.e., “sports car” represents the advertisement as well as the primary webpage), this particular advertisements may be selected for serving to the user.

The additional content server 215 may be part of a network service provider (such as Yahoo! and its associated properties) that provide users an entrance and guide into the resources of the Internet. The network service provider may include one or more search engine servers 220, one or more base content servers 210, and/or one or more additional content servers 215 to provide a range of search, email, news, shopping, and other content and services. In other embodiments, the base content server 210, the additional content server 215, and/or search engine server 220 may be operated by separate entities.

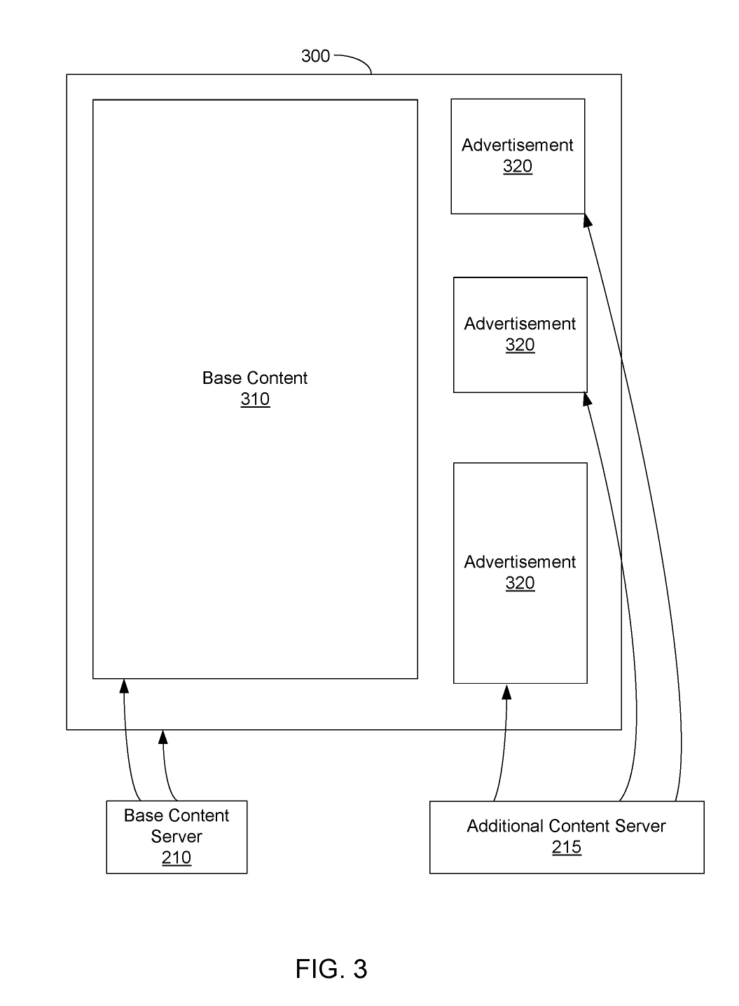

FIG. 3 is a block diagram of an exemplary interface 300 for displaying base content and additional content according to some embodiments. The interface 300 may be implemented and displayed by the client system 205 (e.g., via a web browsing program). The interface may comprise a webpage 300, such as a primary webpage requested by a user, received from a base content server 210. The webpage may incorporate base content 310 received from a base content server 210 and/or additional content (advertisements) 320 received from an additional content server 215. The base content may include, for example, articles, and/or other information of interest to users, often displayed in a variety of formats, such as text, video, audio, hyperlinks, or other formats.

In some embodiments, the webpage 300 also includes data regarding the referrer of the webpage 300 (e.g., a URL address of the prior referring webpage from which the webpage 300 was retrieved), for example, attached to the metadata field of the webpage 300). The primary webpage may further include an embedded advertisement request mechanism (e.g., iframe mechanism, JavaScript code, etc.) configured to make an advertisement request (e.g., HTTP request) to an additional content server 215 to send one or more advertisements to serve with the primary webpage. In some embodiments, the embedded advertisement request mechanism is configured to read the data regarding the referrer of the webpage 300 (e.g., read the referrer data from the metadata field of the webpage 300) and include the referrer data in the advertisement request to the additional content server. In other embodiments, the embedded advertisement request mechanism is configured to extract one or more terms from the referrer data and include the one or more extracted terms in the advertisement request to the additional content server. The advertisement request mechanism embedded in the webpage 300 may be configured to perform these operations, for example, upon the webpage 300 being received and displayed by the client system. As advertisements are received, they may be displayed with the webpage 300. In some embodiments, the received advertisements are included and displayed within the webpage 300 as additional content 320.

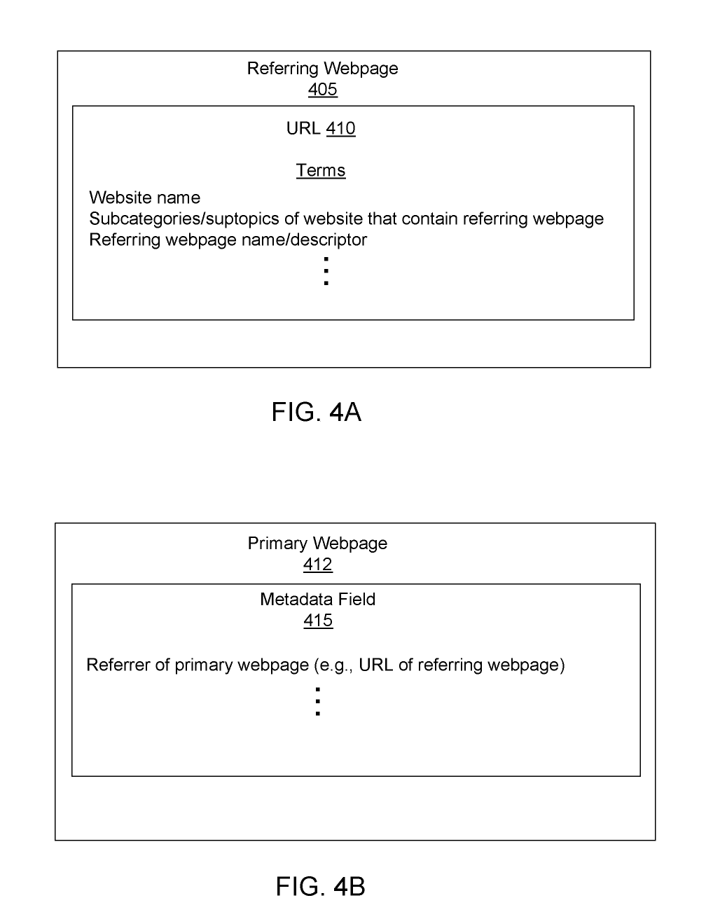

FIG. 4A shows an exemplary referring webpage 405 having a URL address 410. The URL address 410 of the referring webpage 405 typically contains one or more terms that describe or are related to the referring webpage 405. Such terms may include, for example, website name or uniform resource locator URL (e.g., www.generichardwarestore.com), subcategories/subtopics of the website that contain the referring webpage (e.g., outdoor/lawn/tools), referring webpage name/descriptor (e.g., shovels), etc. In other embodiments, the URL address 410 of the referring webpage 405 may include other types of terms that describe or are related to the referring webpage 405.

FIG. 4B shows an exemplary primary webpage 412 having a metadata section 415. The primary webpage 412 is stored and maintained by a base content server that receives and responds to requests for the primary webpage 412 from client systems. A request for the primary webpage 412 typically contains a referrer of the primary webpage (e.g., URL address of the prior referring webpage from which the primary webpage 412 was retrieved). In some embodiments, the base content server writes the referrer to the metadata sections 415 of the primary webpage 412 prior to sending the primary webpage 412 to the client system.

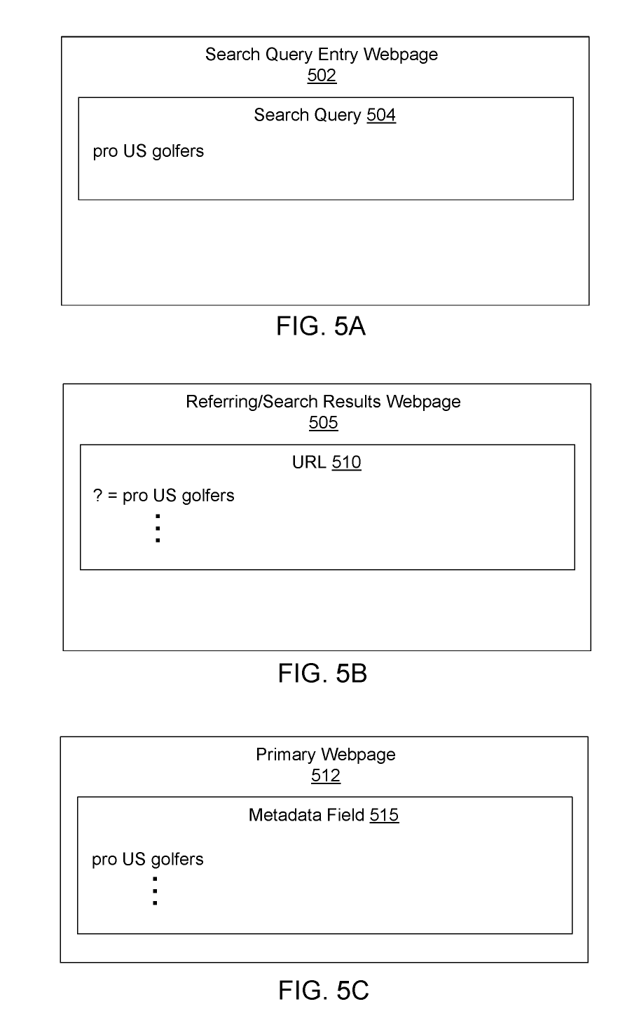

In some embodiments, a user/client system may submit a search query to a search engine server. FIG. 5A shows an exemplary search query entry webpage 502 having a search query interface 504 for receiving, from a user, a search query comprising one or more terms (e.g., “pro US golfer”). The search query is sent to a search engine server that, in response, returns a search results webpage (the referring webpage) showing search results (e.g., in the form of one or more hyperlinks to one or more landing webpages). When creating the search results webpage, the search engine server typically attaches the received search query terms to the URL address of the search results webpage (referring webpage). FIG. 5B shows an exemplary search results/referring webpage 505 having a URL address 510 containing attached search query terms (e.g., “pro US golfer”).

The search query may be attached to the URL of the search results webpage 505, for example, as attribute-value pairs. Currently, several different attribute names are used to indicate a search query in the URL of a webpage. FIG. 5B shows an example of an attribute name “?” used for indicating a search query in the URL of a webpage. Various examples of attribute-value pairs include:

| attribute name - | search query value |
|---|---|
| “?” | “pro US golfers” |
| “tag” | “pro US golfers” |
| “search” | “pro US golfers” |
| “C” | “pro US golfers” |

FIG. 5C shows an exemplary primary webpage 512 having a metadata section 515. The primary webpage 512 is stored and maintained by a base content server that receives and responds to requests for the primary webpage 512 from client systems. A request for the primary webpage 512 typically contains a URL address (and hence search query terms) of the prior search results/referring webpage from which the primary webpage 512 was retrieved. In some embodiments, the base content server writes the URL address 510 of the referring webpage 505 (and hence writes the search query terms) to the metadata section 515 of the primary webpage 512 prior to sending the primary webpage 512 to the client system.

### Section II: Retargeting Advertisements Based on Previously Captured Relevance Data

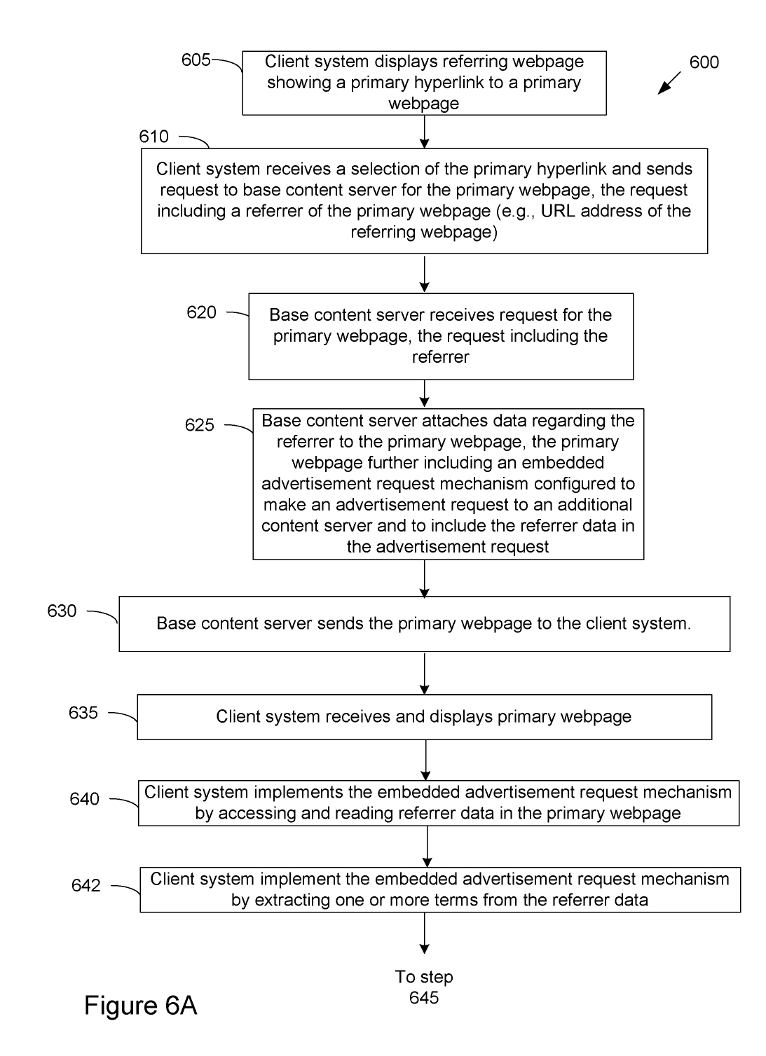

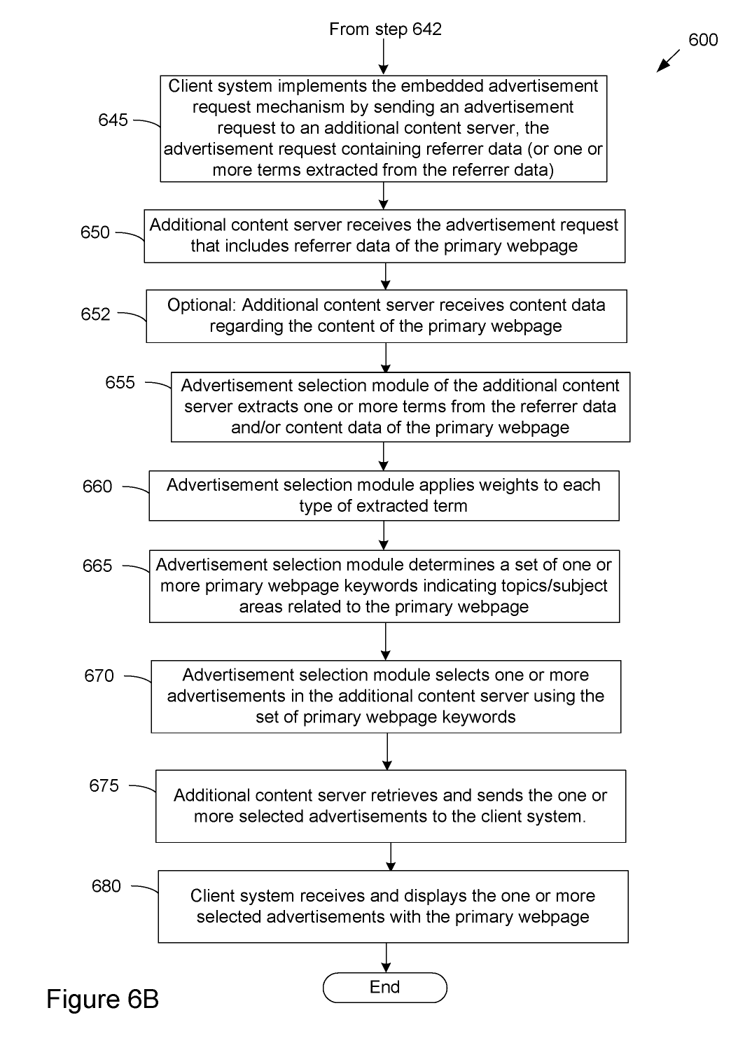

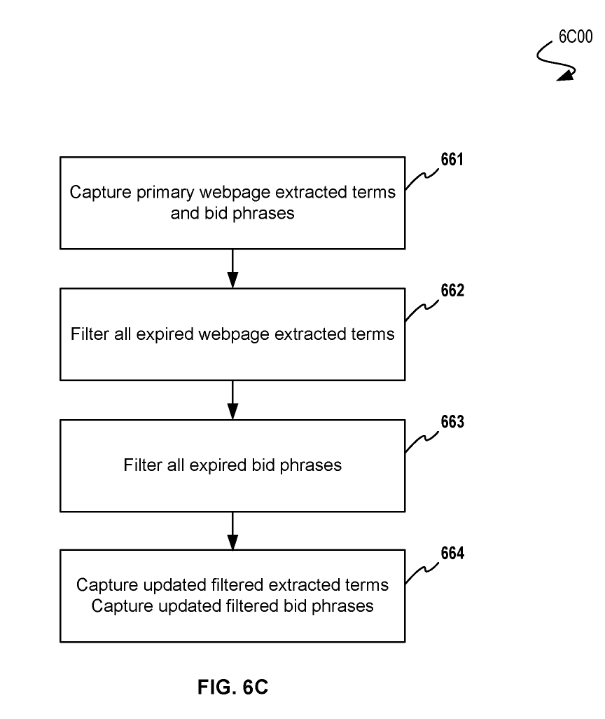

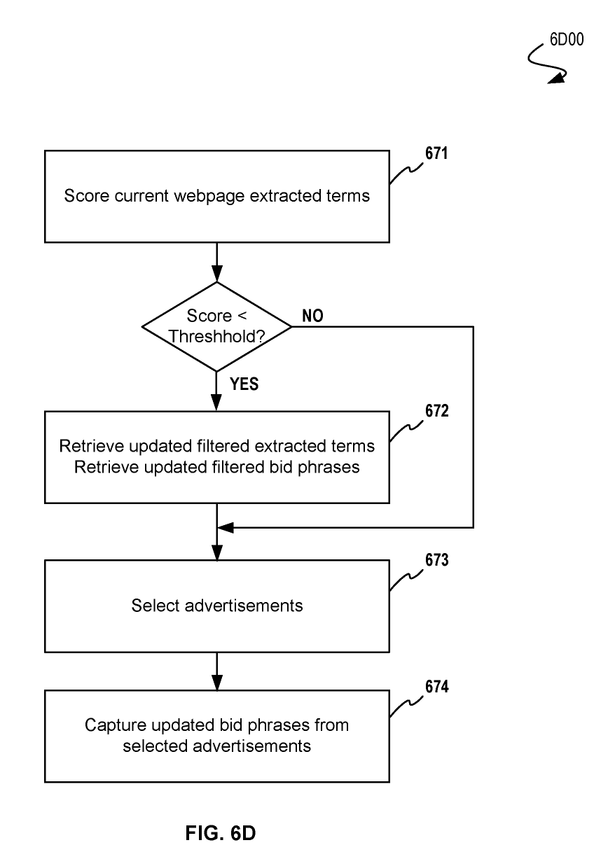

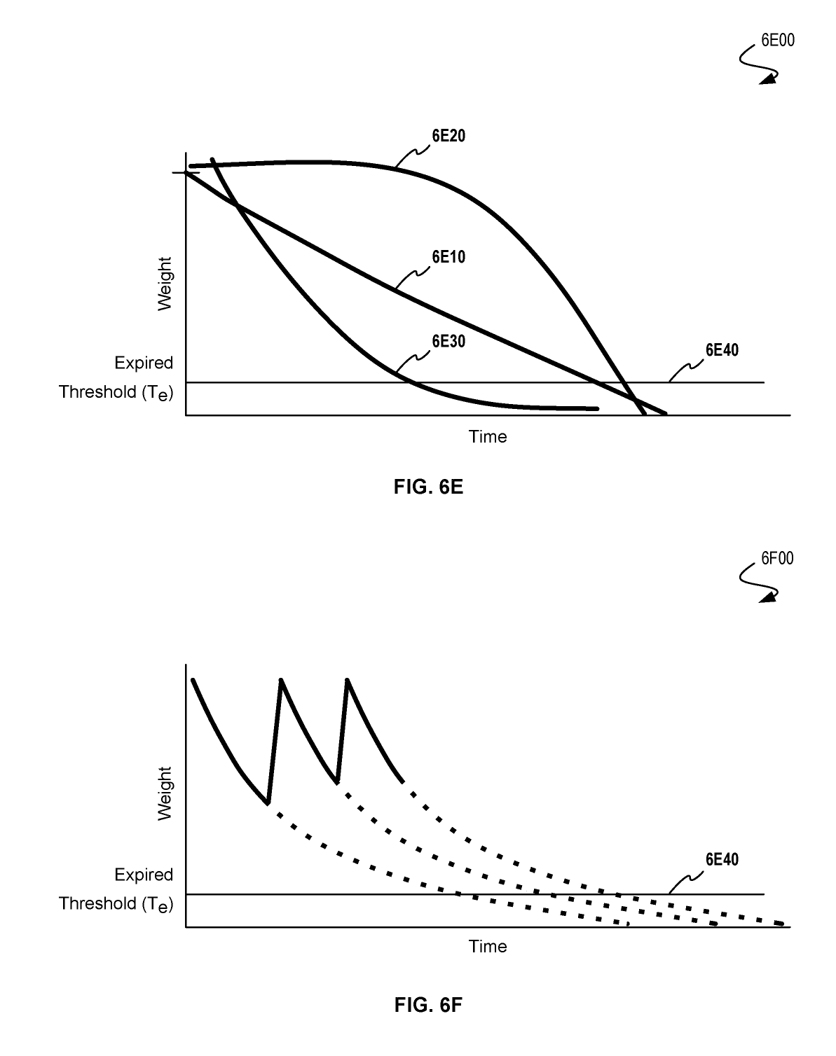

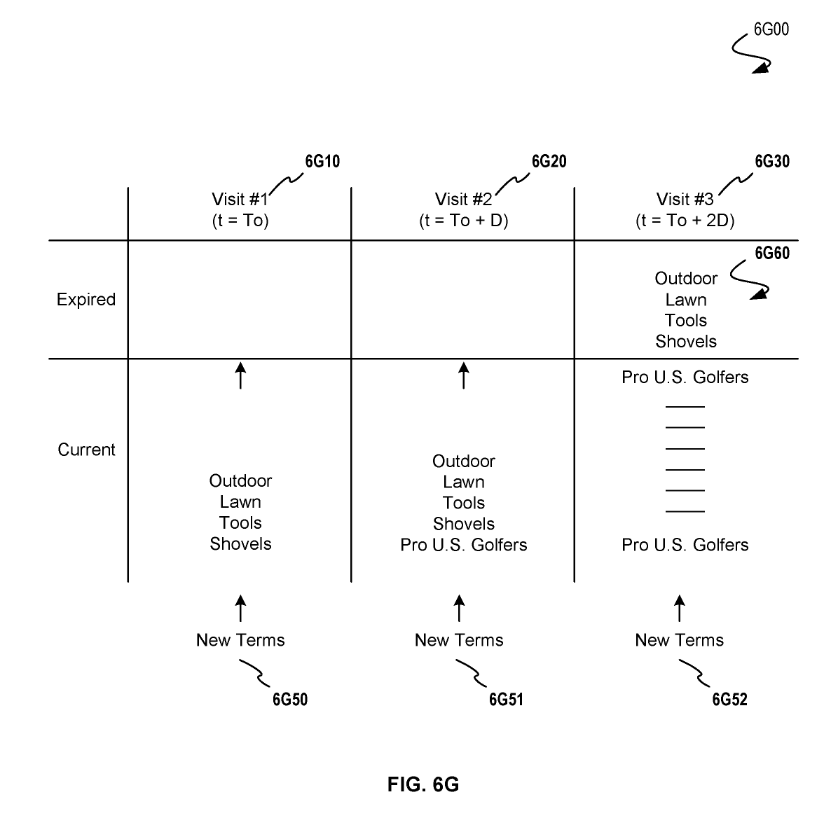

FIGS. 6A-D are flowcharts of a method 600 for selecting one or more advertisements to serve to a user/client system requesting a webpage. In some embodiments, the method 600 is implemented by software or hardware configured to select the advertisements. In some embodiments, the steps of method 600 are performed using one or more servers (such as base content server 210 and additional content server 215), one or more modules (such as advertisement selection module 245), and/or one or more client systems (such as client system 205). The order and number of steps of the method 600 are for illustrative purposes only and, in other embodiments, a different order and/or number of steps are used.

The method 600 begins when the client system displays (at 605) an initial webpage (the referring webpage) that shows one or more hyperlinks to one or more landing webpages. The client system then receives (at 610) a selection of one of the hyperlinks (the primary hyperlink) by a user and sends a request to a base content server that stores and maintains the selected landing webpage (the primary webpage) of the selected hyperlink. The client system (e.g., via the web browser program) includes a referrer of the primary webpage (e.g., a URL address of the prior referring webpage from which the primary webpage was retrieved) in the request for the primary webpage.

The base content server receives (at 620) the request for the primary webpage (the request including the referrer of the primary webpage). The base content server then attaches (at 625) data regarding the referrer to the primary webpage (e.g., attached to the metadata field of the primary webpage). The primary webpage further includes an embedded advertisement request mechanism configured to make an advertisement request to an additional content server to send one or more advertisements to serve with the primary webpage. In some embodiments, the embedded advertisement request mechanism may be further configured to read data regarding the referrer of the primary webpage (e.g., read the referrer data from the metadata field of the primary webpage) and include the referrer data in the advertisement request to the additional content server. The base content server sends (at 630) the primary webpage to the client system.

The client system receives and displays (at 635) the primary webpage from the base content server. Upon doing so, the client system implements the embedded advertisement request mechanism by accessing and reading (at 640) referrer data in the primary webpage. In some embodiments, the client system may implement the advertisement request mechanism by extracting (at 642) one or more terms from the referrer data in the primary webpage. The client system further implements the embedded advertisement request mechanism by sending (at 645) an advertisement request to an additional content server to send one or more advertisements to serve with the primary webpage, wherein the advertisement request contains referrer data (or one or more terms extracted from the referrer data). The additional content server receives (at 650) the advertisement request (that includes referrer data of the primary webpage and/or terms extracted from the referrer data).

As an optional step, content data regarding the content of the primary webpage is received (at 652) by the additional content server 215 as well. The content data comprises data of the content of primary webpage which may comprise items such as text (e.g., news articles, movie reviews, etc.), graphics, images, animation, video, audio, etc. that are presented in the primary webpage. Primary webpage content also typically includes one or more hyperlinks to one or more landing webpages. The content data of the primary webpage may be sent to the additional content server 215 using a variety of methods known in the art. For example, the content data may be included in the advertisement request sent by the advertisement request mechanism to the additional content server 215. As a further example, the advertisement request sent to the additional content server 215 may include the URL of primary webpage wherein the additional content server 215 then issues an HTTP request to the base content server 210 to receive the content data of primary webpage.

The advertisement selection module 245 of the additional content server then extracts (at 655) one or more terms from the referrer data and, optionally, also extracts one or more terms from the content data of the primary webpage (using, for example, a set of extraction rules). The advertisement selection module then applies (at 660) weights to each type of extracted terms, such as different weights for terms extracted from the referrer data and terms extracted from the primary webpage content data.

In some embodiments, any weights applied (at 660) might account for any prior user sequence/activity data captured during traversal between any referrer webpage to the primary webpage. As shown in FIG. 6C, the primary page extracted terms (possibly including bid phrases) are captured (at operation 661) for subsequent analysis and filtering (at operation 662). More specifically, any webpage term or bid phrase encountered during traversal between any referrer webpage to the primary webpage might become expired over time. That is, any webpage term or bid phrase might be timestamped at the moment of first encounter, and that timestamp might be compared to the current time. Older webpage terms or bid phrases might become weighted as less relevant over time, and at some point may become expired. Of course over some definable period of time, any and all older webpage terms or bid phrases might become expired.

The notion that terms have relevance that persists over some duration of time is termed relevance persistence. The aforementioned applied weights and corresponding persistence in time might be applied via some algorithm such as ‘decay the weight value linearly at each iteration, and consider any term with a weight value less than Tₑ as expired’ (see curves 6E10 and threshold 6E40). More sophisticated models for decay are reasonable and envisioned including delayed decay (curve 6E20), and inverse decay (curve 6E30). Some models for filtering include heuristics that assign a specific decay model for a particular term or bid phrase on the basis of results of cluster analysis of the full set of unexpired terms and bid phrases. For example, a cluster analysis that places the term “orange” within proximity to “Pontiac GTO” might distinguish uses of the term “orange” as an adjective (e.g. a color) from any uses of the term “orange” as a noun (e.g. a citrus fruit). An exemplary model using a heuristic is shown in the graph 6F00 where (strictly for example) a revisit to a particular webpage refreshes the weight of the refreshed terms. Any data that remains at any time in any filter structure (e.g. a data structure or a data record) regardless if the data is discrete or accumulated, is considered historical relevance data for the purposes of the disclosure herein.

As indicated in the foregoing paragraphs, an embodiment might include a filter structure or data structure adapted for managing time-related weighting and expiration of terms. As shown in FIG. 6G, upon each webpage visit or other event (6G10), any terms or any form of relevance data may be entered into a data structure (at 6G50, 6G51, 6G52) and retained for some period. Upon a subsequent webpage visit or other subsequent event (6G20, 6G30) additional terms or any form of relevance data might be entered into the data structure. The data structure supports updating with respect to time; that is, any item pushed in at some time (e.g. time=T₀) might be retained in the data structure in a first-in-first-out (FIFO), or circular ring, or other such structure. At some later time (e.g. time=T₀+D), new terms might be pushed in (e.g. at 6G51). Similarly at some later time (e.g. time=T₀+2D), new terms might be pushed in (e.g. at 6G52) while old terms might be pushed out (e.g. at 6G60). In some exemplary cases, any second or nth visit might update the data structure as a function of elapsed time. In such a case it is possible for the data structure to become empty merely by the passage of time (i.e. in absence of any user webpage traversals or events). As shown, the differences in the data structure between Visit #2 and Visit #3 indicates passage of time between the two visits and, as a result, old terms (e.g. Outdoor, Lawn, Tools, Shovels) have expired (at 6G60).

Using the extracted terms and their respective weights, the advertisement selection module then determines (at 665) a set of one or more primary webpage keywords indicating topics/subject areas that are related to the primary webpage or that may be of interest to the user. In some embodiments (and the discussion of FIG. 6C notwithstanding), only the terms extracted from the referrer data is considered whereby the set of primary webpage keywords comprises the extracted terms themselves.

The advertisement selection module then applies one or more selection algorithms (at 670) for selecting one or more advertisements in the additional content server, possibly using the set of primary webpage keywords (e.g., by matching or comparing primary webpage keywords with keywords associated with the advertisements).

Of course, in the context of retargeting advertisements based on previously captured relevance data, the selection algorithms 670 might include decision steps to determine if the primary webpage has sufficient content to warrant selection of advertisements based solely on the set of primary webpage keywords. That is, an algorithm such as depicted in FIG. 6D might score the primary webpage keywords (at 671) and make a decision if the value resulting from scoring the primary webpage keywords is sufficient for selecting advertisements (at 673). If not, then the captured, updated, filtered, and extracted terms and bid phrases (see operation 664) might be retrieved and used for selecting advertisements (at 673). Of course, the selection of advertisements (at 673) provides one or more advertisements from which to capture bid phrases. Those bid phrases might be deemed as relevant and captured (at 674).

The additional content server then retrieves and sends (at 675) the one or more selected advertisements to the client system. The client system receives and displays (at 680) the one or more selected advertisements with the primary webpage. The method 600 then ends.

As discussed above, the method 600 uses (in steps 655 to 670) data regarding the referrer of a primary webpage (e.g., an URL address of the prior referring webpage from which the primary webpage was retrieved), as well as data from previously captured relevance data, can be used to select one or more advertisements to serve with the primary webpage.

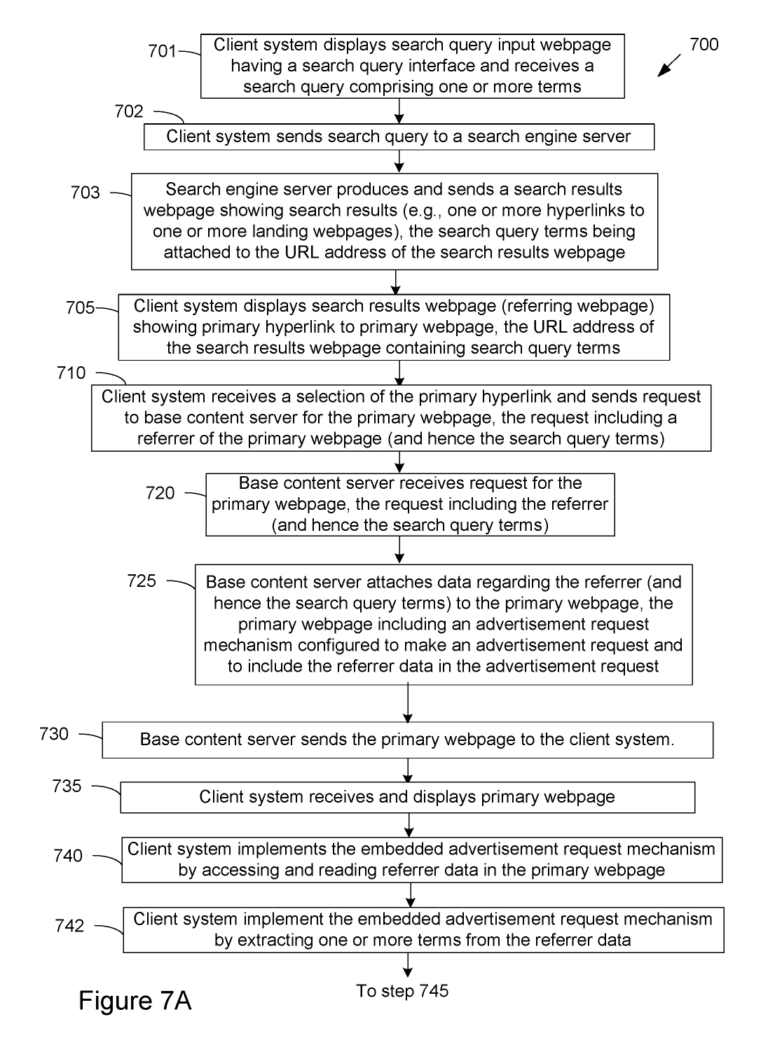

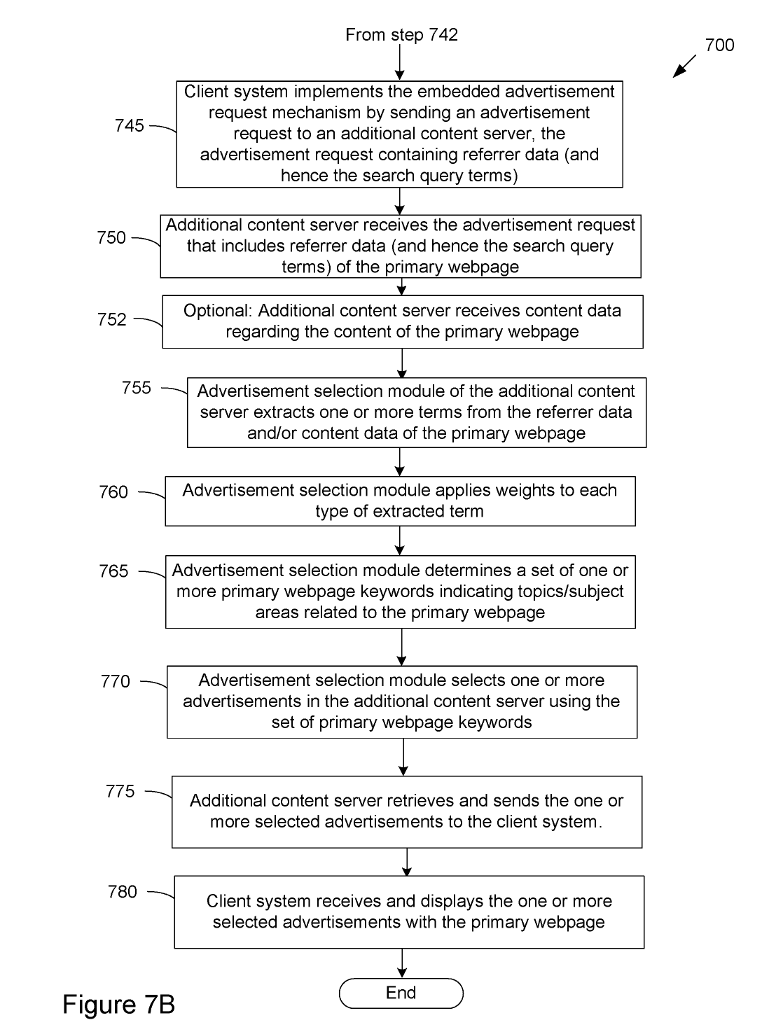

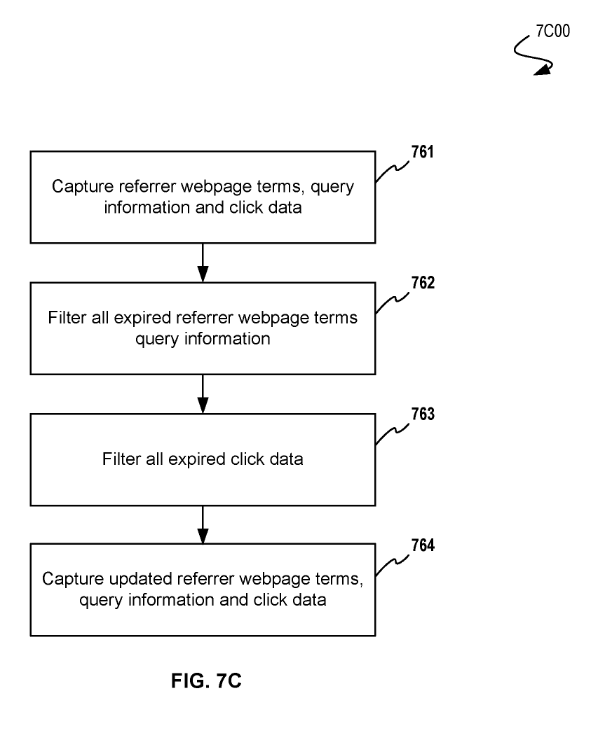

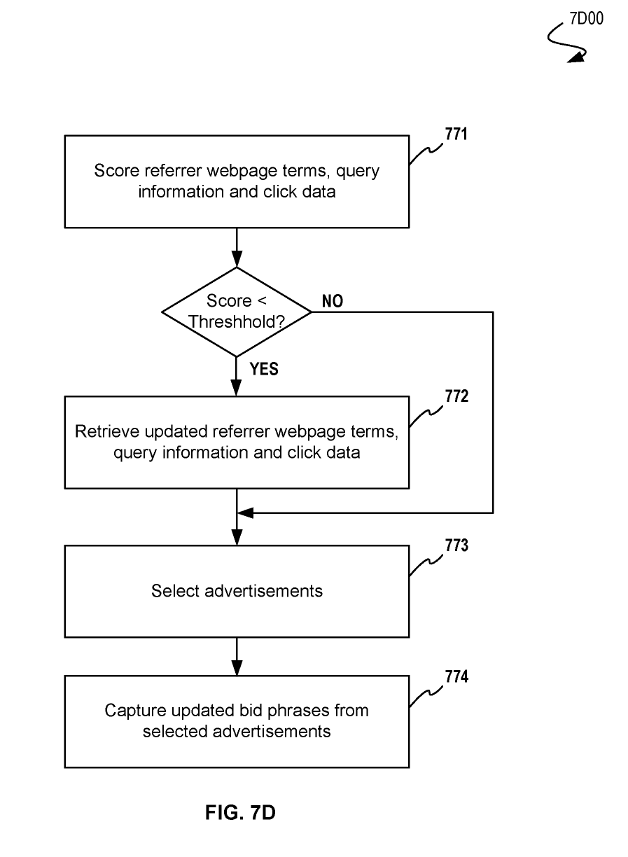

FIGS. 7A-D are flowcharts of a method 700 for selecting one or more advertisements to serve to a user/client system performing a search query and requesting a webpage. In some embodiments, the method 700 is implemented by software or hardware configured to select the advertisements. In some embodiments, the steps of method 700 are performed using one or more servers (such as search engine server 220, base content server 210, and additional content server 215), one or more modules (such as advertisement selection module 245), and/or one or more client systems (such as client system 205). The order and number of steps of the method 700 are for illustrative purposes only and, in other embodiments, a different order and/or number of steps are used. Some of the steps of the method 700 are similar to the steps of the method 700 of FIG. 7 and only those steps that differ are discussed in detail here.

The method 700 begins when the client system displays (at 701) an initial webpage (the search query input webpage) having a search query interface and receives a search query (comprising one or more terms) from a user. The client system sends (at 702) the search query to a search engine server 220 that performs a search over a network (e.g., Internet) for webpages based on the search query to produce a set of search results. The search engine server 220 produces and sends (at 703) a search results webpage showing search results (e.g., as one or more hyperlinks to one or more landing webpages), wherein the search engine server 220 attaches the search query to the URL address of the search results webpage.

The client system then receives and displays (at 705) the search results webpage (the referring webpage) that shows one or more hyperlinks to one or more landing webpages, the URL address of the search results webpage containing search query terms. The client system then receives (at 710) a selection of one of the hyperlinks (the primary hyperlink) and sends a request to a base content server that stores and maintains the selected landing webpage (the primary webpage) of the selected hyperlink. The client system includes a referrer of the primary webpage (and hence the search query terms) in the request for the primary webpage.

The base content server receives (at 720) the request for the primary webpage (the request including the referrer of the primary webpage and hence the search query terms). The base content server then attaches (at 725) data regarding the referrer to the primary webpage (and hence attaches data regarding the search query terms to the primary webpage). The primary webpage further includes an embedded advertisement request mechanism. The base content server sends (at 730) the primary webpage to the client system.

The client system receives and displays (at 735) the primary webpage from the base content server. Upon doing so, the client system implements the embedded advertisement request mechanism by accessing and reading (at 740) referrer data in the primary webpage, extracting (at 742) one or more terms from the referrer data in the primary webpage, and sending (at 745) an advertisement request to an additional content server, wherein the advertisement request contains referrer data (and hence contains search query terms). The additional content server receives (at 750) the advertisement request (that includes referrer data of the primary webpage and hence search query terms). As an optional step, content data of the primary webpage is received (at 752) by the additional content server 215 as well.

The advertisement selection module 245 of the additional content server then extracts (at 755) one or more terms from the referrer data (containing search query terms) and, optionally, also extracts one or more terms from the content data of the primary webpage. The advertisement selection module then applies (at 760) weights to each type of extracted term.

In some embodiments, weights applied might account for any prior user sequence/activity data captured during traversal between any referrer webpage to the primary webpage. As shown in FIG. 7C, the referrer webpage extracted terms (possibly including query information) and click data are captured (at operation 761) for subsequent analysis and filtering (at operation 762). More specifically, any referrer webpage extracted terms or query encountered during traversal between any referrer webpage to the primary webpage might be filtered over time. That is, any referrer webpage extracted terms or query might be timestamped at the moment of first encounter, and that timestamp might be compared to the current time. Older referrer webpage extracted terms or queries or click data might become weighted as less relevant over time, and at some point may become expired, and of course over some definable period of time, any and all older referrer webpage extracted terms or queries or click data might become expired. The aforementioned applied time-based decayed or refreshed weights might be applied by some algorithm or curves (see graph 6E00) such as previously disclosed.

Using the extracted terms and their respective weights, the advertisement selection module then determines (at 765) a set of one or more primary webpage keywords related to the primary webpage. In some embodiments, (and the discussion of FIG. 6C notwithstanding) only the terms extracted from the referrer data (containing search query terms) is considered whereby the set of primary webpage keywords comprises the extracted terms themselves.

The advertisement selection module then applies one or more selection algorithms (at 770) for selecting one or more advertisements in the additional content server, possibly using the set of primary webpage keywords.

Of course, in the context of retargeting advertisements based on previously captured relevance data, the selection algorithms 770 might include decision steps to determine if the primary webpage has sufficient content to warrant the selection of advertisements based solely on the set of primary webpage keywords. That is, an algorithm such as depicted in FIG. 7D might score the referrer webpage keywords (at 771) and make a decision if the value resulting from scoring the referrer webpage keywords is sufficient for selecting advertisements (at 773). If not, then the captured, updated, filtered, and extracted referrer webpage terms, query information, and click data (see operation 764) might be retrieved and used for selecting advertisements (at 773). Of course, the selection of advertisements (at 773) provides one or more advertisements from which to capture bid phrases. Those bid phrases might be deemed as relevant and therefore captured (at 774).

The additional content server then retrieves and sends (at 775) the one or more selected advertisements to the client system. The client system receives and displays (at 780) the one or more selected advertisements with the primary webpage. The method 700 then ends.

As discussed above, the method 700 uses (in steps 755 to 770) data regarding the referrer of a primary webpage (the referrer containing search query terms), as well as data from previously captured relevance data to select one or more advertisements to serve with the primary webpage.

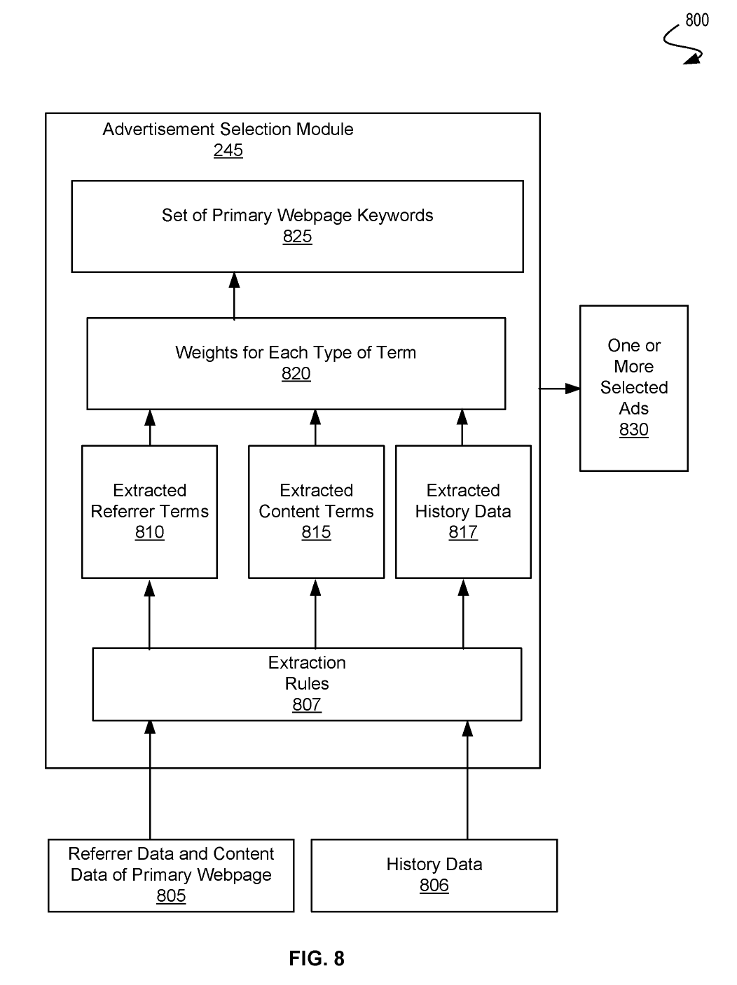

FIG. 8 shows a conceptual diagram of the operation of the advertisement selection module 245 of the additional content server 215 in selecting advertisements to serve to a client system that requests a primary webpage. The advertisement selection module 245 may be implemented in software or hardware configured to perform the functions described below.

As shown in FIG. 8, the advertisement selection module 245 receives inputs 805 and 806 comprising referrer data and content data of the requested primary webpage and history data. Content data includes data regarding content displayed on the primary webpage (e.g., hyperlinks, text, graphics, images, animation, video, audio, etc.). History data includes browser history and/or clicks, and or any other data that remains in any filter structure. As discussed above, referrer data is data regarding the referrer of the primary webpage (which may or may not contain search query terms). Also as discussed above, relevance data is any data that remains at any time in any filter structure based on user behavior during the traversal to the primary webpage (which primary webpage may or may not contain search query terms). The advertisement selection module 245 then applies a set of extraction rules 807 to extract terms from the content and referrer data 805 and history data 806. In some embodiments, the set of extraction rules 807 defines a list of attribute names indicating search query terms to be detected in the received referrer data. For example, the set of extraction rules 807 may include commonly used attribute names used to indicate a search query value in the URL of the webpage (e.g., “?,” “tag,” “search,” etc.). In some embodiments, the set of extraction rules 807 defines rules for extraction of relevance data based on the type of event and the temporal juxtaposition of the event to other events. The advertisement selection module 245 searches the received data for attribute names listed in the set of extraction rules 807 to locate and extract search query values (comprising one or more terms).

Using the set of extraction rules 807, the advertisement selection module 245 extracts terms 810 from the referrer data (referrer terms) and terms 815 from the content data (content terms). The advertisement selection module 245 may apply weights 820 to each type of extracted term that reflects the degree of influence the type of term (e.g. referrer term, content term, history term) has on the selection of the advertisements. For example, the referrer terms 810 may be weighted higher than either the content terms 815 or the history terms 817 so that the referrer terms 810 have a greater effect on the selection of the advertisements.

From the extracted terms 810, 815, and 817, the advertisement selection module 245 determines a set of one or more primary webpage keywords 825 indicating topics/subject areas that are related to the requested primary webpage or that may be of interest to the user. Different methods for determining keywords from extracted terms may be used. For example, bid phrases from previously shown advertisements might be used as a proxy for establishing primary page keywords. Methods for determining keywords from content terms are well known in the art and not discussed in detail here. In some embodiments, the referrer terms 810 are considered along with the content terms 815 and history terms 817 in determining the set of primary webpage keywords. In other embodiments, only the referrer terms 810 are considered in determining the set of primary webpage keywords.

The advertisement selection module 245 then selects advertisements in the additional content server 215 based on the set of primary webpage keywords. For example, the advertisement selection module 245 may select those advertisements in the additional content server 215 having an associated keyword that matches one or more of the primary webpage keywords. The one or more selected advertisements 830 are then served to the client system that requested the primary webpage.

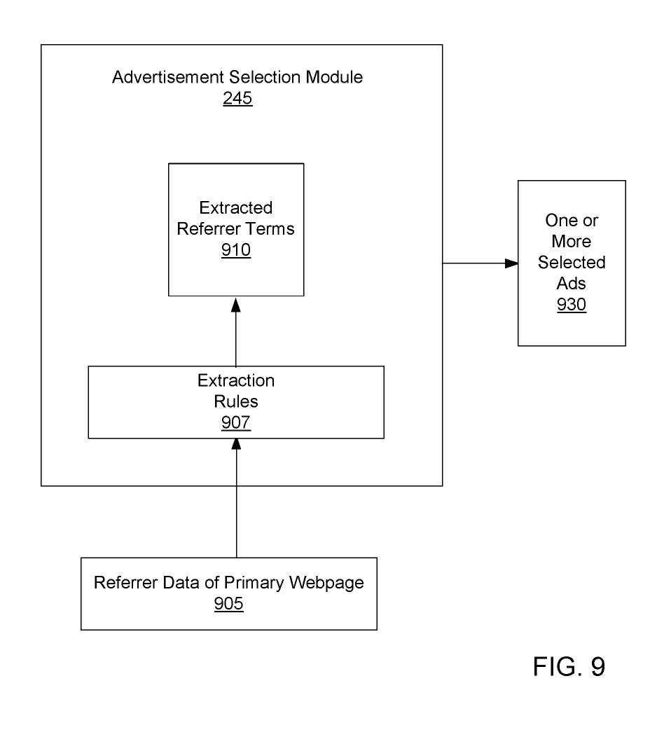

FIG. 9 shows a conceptual diagram of an alternative embodiment of the advertisement selection module 245 in selecting advertisements to serve to a client system that requests a primary webpage. In the embodiment of FIG. 9, only the terms extracted from the referrer data that comprise search query terms is considered in selecting advertisements in a “bidded phrase” setting.

As shown in FIG. 9, the advertisement selection module 245 receives as input referrer data 905 of the primary webpage, the referrer data comprising search query terms submitted by the client system. The advertisement selection module 245 then applies a set of extraction rules 907 (e.g., comprising a list of attribute names indicating search query terms) to extract search query terms 910 from the referrer data 905. The advertisement selection module 245 may then select an advertisement in the additional content server 215 having an associated keywords/terms (i.e., bidded phrase) that matches the search query terms 910. The one or more selected advertisements 930 are then served to the client system that requested the primary webpage.

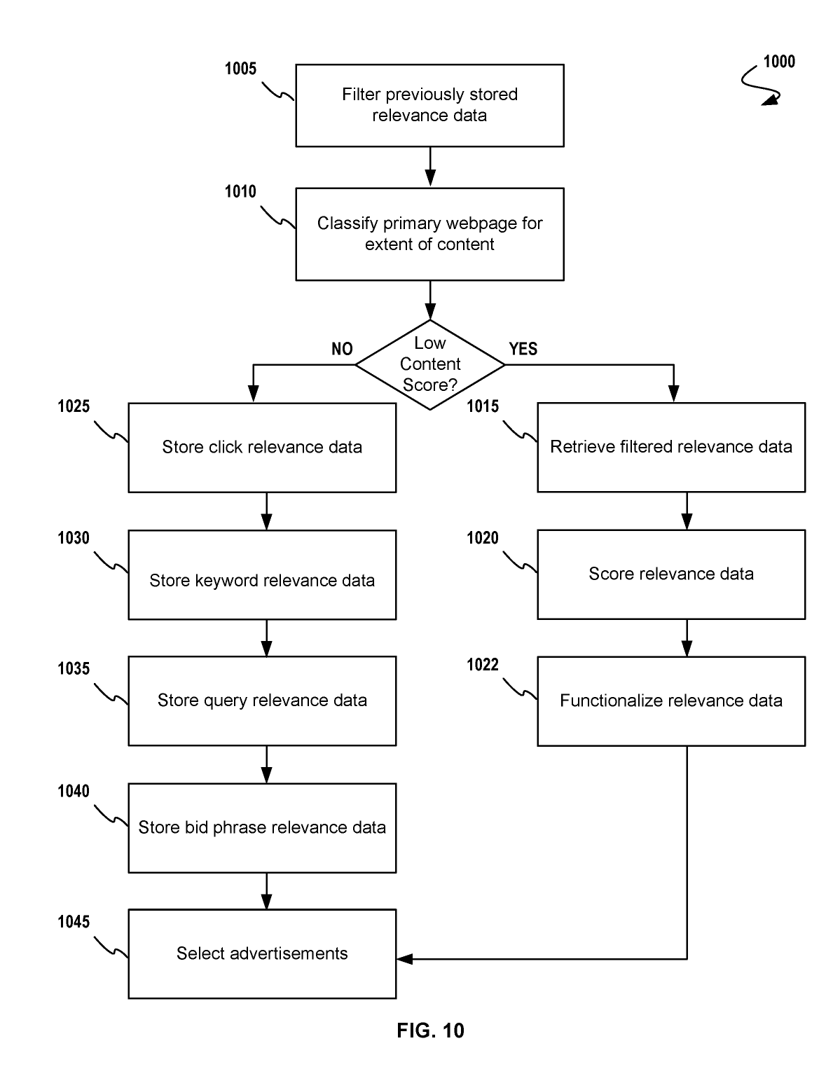

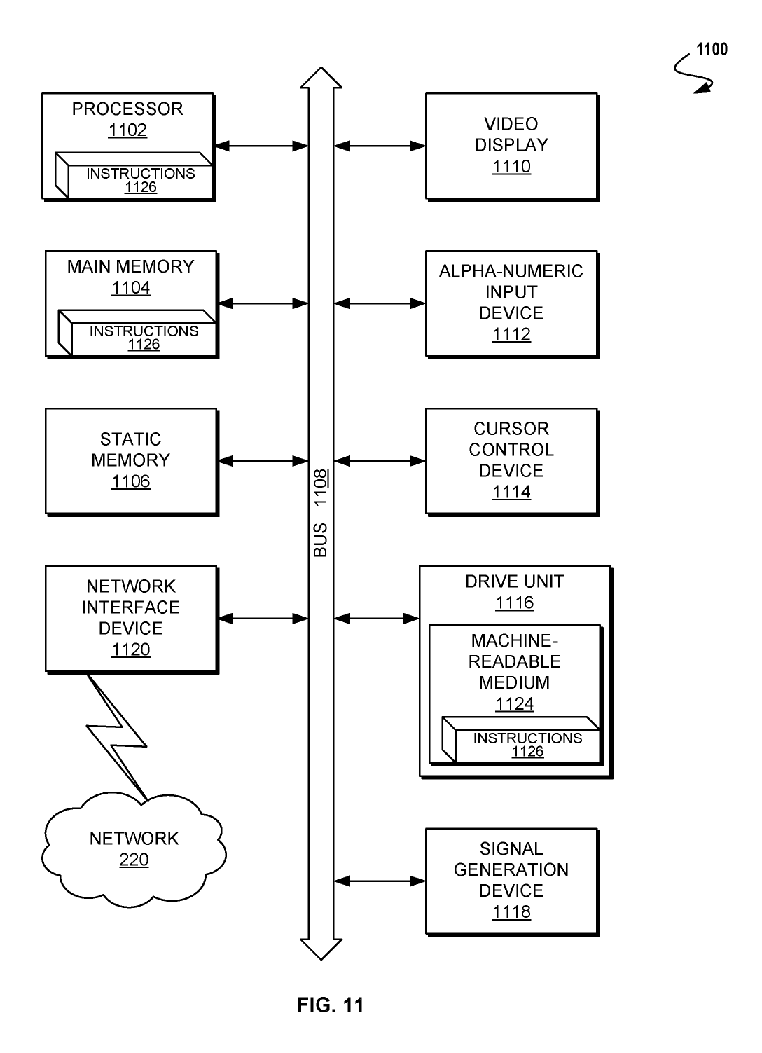

FIG. 10 a flowchart of one embodiment of a method for selecting advertisements to serve based on previously captured relevance data. The embodiment shown is purely exemplary, and might be implemented in the context of one or more of FIG. 1 through FIG. 9. As shown the method 1000 might filter previously captured relevance data (e.g. webpage terms, clicks, and any type of history data). Operation 1010 serves to classify the primary webpage for extent of content. When the content is classified as low, then previously captured relevance data is retrieved 1015, and scored 1020. The relevance data might also be functionalized 1022 before passing to any module or operation for selecting advertisements 1045. It must be emphasized that the operation to functionalize the relevance data might include quantitative analysis, and/or qualitative analysis, and/or heuristics to relate scored relevance data to a set of candidate advertisements for selection 1045. Of course the operation for selecting advertisements 1045 might be implemented in whole or in part within an advertisement selection module 245, or the operation for selecting advertisements 1045 might include any extraction rules 807 or weighting operation 820.

In cases where the primary webpage content is not classified as low, the method 1000 might proceed to process the updated, filtered data as per operation 1005, and such processing might include storing the updated click data 1025, storing the updated keyword data 1030, storing the updated query data 1035, and storing the updated bid phrase data 1040, before selecting advertisements 1045.

In somewhat more general terms, a method for selecting one or more advertisements based on previously captured relevance data to serve to a client system requesting a primary webpage might be described as:
classifying the primary webpage for extent of content;
retrieving previously captured relevance data including relevance data from any history data;
evaluating relevance data for a relevance correspondence to said primary webpage; and
selecting advertisements for presenting on said primary webpage based on the relevance correspondence.

FIG. 11 shows a diagrammatic representation of a machine in the exemplary form of a computer system 1100 within which a set of instructions, for causing the machine to perform any one of the methodologies discussed above, may be executed. The embodiment shown is purely exemplary, and might be implemented in the context of one or more of FIG. 1 through FIG. 10. In alternative embodiments, the machine may comprise a network router, a network switch, a network bridge, a Personal Digital Assistant (PDA), a cellular telephone, a web appliance or any machine capable of executing a sequence of instructions that specify actions to be taken by that machine.

The computer system 1100 includes a processor 1102, a main memory 1104 and a static memory 1106, which communicate with each other via a bus 1108. The computer system 1100 may further include a video display unit 1110 (e.g., a liquid crystal display (LCD) or a cathode ray tube (CRT)). The computer system 1100 also includes an alphanumeric input device 1112 (e.g., a keyboard), a cursor control device 1114 (e.g., a mouse), a disk drive unit 1116, a signal generation device 1118 (e.g., a speaker), and a network interface device 1120.

The disk drive unit 1116 includes a machine-readable medium 1124 on which is stored a set of instructions (i.e., software) 1126 embodying any one, or all, of the methodologies described above. The software 1126 is also shown to reside, completely or at least partially, within the main memory 1104 and/or within the processor 1102. The software 1126 may further be transmitted or received via the network interface device 1120 over the network 220.

It is to be understood that embodiments of this invention may be used as, or to support, software programs executed upon some form of processing core (such as the CPU of a computer) or otherwise implemented or realized upon or within a machine or computer readable medium. A machine readable medium includes any mechanism for storing or transmitting information in a form readable by a machine (e.g., a computer). For example, a machine readable medium includes read-only memory (ROM); random access memory (RAM); magnetic disk storage media; optical storage media; flash memory devices; electrical, optical, acoustical or other form of propagated signals (e.g., carrier waves, infrared signals, digital signals, etc.); or any other type of media suitable for storing or transmitting information.

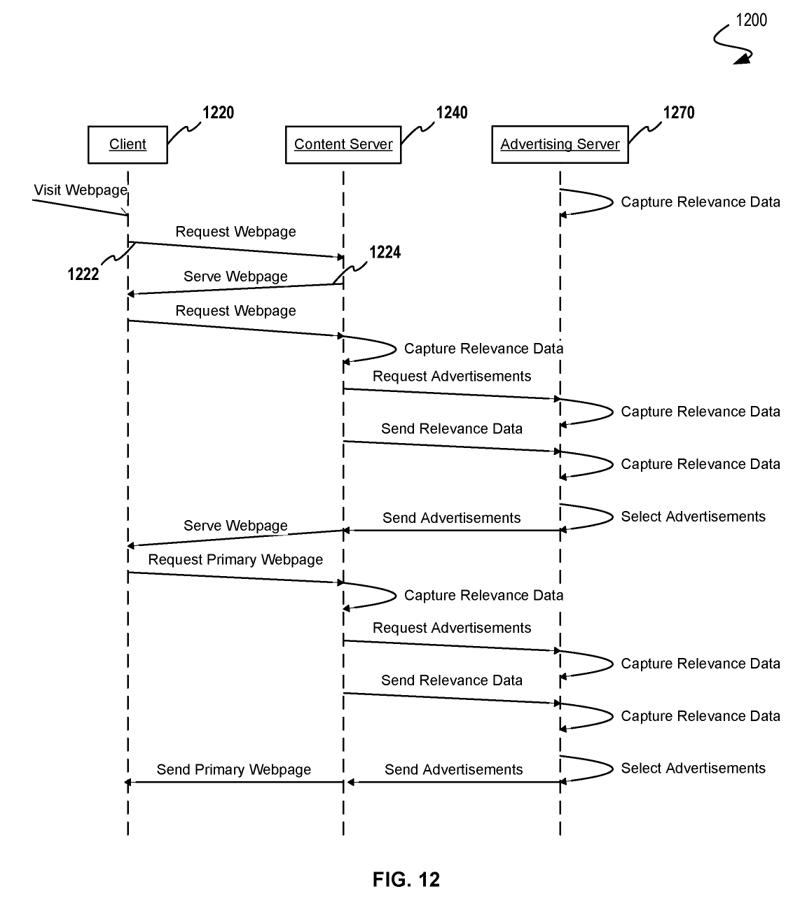

FIG. 12 is a diagrammatic representation of several computer systems (i.e. client, content server, advertising server) in the exemplary form of a client server network 1200 within which environment a communication protocol may be executed. The embodiment shown is purely exemplary, and might be implemented in the context of one or more of FIG. 1 through FIG. 11. As shown the client 1220 is capable of initiating a communication protocol by requesting a webpage (transaction 1222). Such a request might be satisfied solely by a content server 1240, or it might be satisfied by a content server 1240 and any number of additional content servers or advertising servers 1270 acting in concert. In general, and as shown in the exemplary embodiment, any server might be capable of capturing various forms of relevance data, and/or sending relevance data to another server. Strictly for illustrative purposes, any server might be configured for implementing a method for selecting one or more advertisements based on previously captured relevance data to serve to a client system requesting a primary webpage. The server operations might include capturing relevance data (e.g. search term data, historical click data), receiving and/or retrieving previously captured relevance data, classifying the primary webpage based on content, evaluating all or part of any relevance data for a relevance correspondence to the (now classified) primary webpage, and selecting content (possibly including advertisements) for presenting on the primary webpage. As shown, the operations for capturing relevance data (e.g. referrer webpage URL, search terms, clicks, etc) might execute on any server, and the decision as to which relevance data is captured by which server, and at what relative time in the communication protocol is a matter of convenience; thus any server (or client for that matter) can operate to capture various relevance data.

While the invention has been described with reference to numerous specific details, one of ordinary skill in the art will recognize that the invention can be embodied in other specific forms without departing from the spirit of the invention. Thus, one of ordinary skill in the art would understand that the invention is not to be limited by the foregoing illustrative details, but rather is to be defined by the appended claims.

We claim:

1. A method for selecting one or more advertisements based on previously captured relevance data to serve to a client system, the method comprising:
selecting advertisements for presenting on a first webpage;
capturing relevance data; and
selecting advertisements, using said relevance data for presenting on a second webpage.

2. The method of claim 1, further comprising
classifying the second webpage for extent of content;
retrieving said previously captured relevance data;
evaluating said relevance data for a relevance correspondence to said second webpage; and
selecting advertisements for presenting on said second webpage wherein said selecting includes using said relevance correspondence.

3. The method of claim 2, wherein said classifying the second webpage for extent of content includes classifying based on at least one of, referrer query data, second webpage keyword data, click history data.

4. The method of claim 2, wherein said retrieving previously captured relevance data includes retrieving at least one of, referrer query data, second webpage keyword data, click history data.

5. The method of claim 2, wherein said evaluating relevance data for a relevance correspondence to the second webpage includes at least one of, heuristic analysis, qualitative analysis, quantitative analysis.

6. The method of claim 2 wherein said selecting advertisements for presenting on said second webpage includes selecting at least one of, a previously presented advertisement, an advertisement based at least in part on a previously presented advertisement, an advertisement based on characteristics of said second webpage.

7. The method of claim 2, wherein said selecting advertisements for presenting on said second webpage includes selecting based on at least one of, characteristics of said second webpage keywords, characteristics of click data, characteristics of a second webpage query.

8. A system for implementing a method for selecting one or more advertisements based on previously captured relevance data to serve to a client system requesting a primary webpage, the method comprising:
capturing relevance data;
receiving previously captured relevance data;
classifying said primary webpage based on content;
evaluating said relevance data for a relevance correspondence to said classified primary webpage; and
selecting advertisements for presenting on said primary webpage wherein said selecting includes using said relevance correspondence.

9. The system of claim 8, wherein said classifying the primary webpage for extent of content includes classifying based on at least one of, referrer query data, primary webpage keyword data, click history data.

10. The system of claim 8, wherein said receiving previously captured relevance data includes receiving at least one of, referrer query data, primary webpage keyword data, and/or click history data.

11. The system of claim 8, wherein said evaluating said relevance data for a relevance correspondence to the primary webpage includes at least one of, heuristic analysis, qualitative analysis, quantitative analysis.

12. The system of claim 8, wherein said selecting advertisements for presenting on said primary webpage includes selecting at least one of, a previously presented advertisement, an advertisement based at least in part on a previously presented advertisement, an advertisement based on characteristics of said primary webpage.

13. The system of claim 8, wherein said selecting advertisements for presenting on said primary webpage includes selecting based on at least one of, characteristics of said primary webpage keywords, characteristics of click data, characteristics of a primary webpage query.

14. The system of claim 8, wherein said selecting advertisements for presenting on said primary webpage includes selecting based on the results of a cluster analysis.

15. A system for implementing a method for selecting one or more advertisements based on previously captured relevance data to serve to a client system requesting a primary webpage, the method comprising:
capturing relevance data;
evaluating said relevance data for a relevance correspondence to said primary webpage sending relevance data; and
sending said primary webpage to a client system.

16. The system of claim 15, wherein said capturing relevance data includes capturing at least one of, referrer query data, primary webpage keyword data, click history data.

17. The system of claim 15, wherein said evaluating said relevance data for a relevance correspondence to the primary webpage includes at least one of, heuristic analysis, qualitative analysis quantitative analysis.

18. The system of claim 15, wherein said sending relevance data includes sending at least one of, a referrer uniform resource locator, a search term, click data.

19. The system of claim 15, wherein said sending said primary webpage to a client system includes sending at least one of, a previously presented advertisement, an advertisement based at least in part on a previously presented advertisement, an advertisement based on characteristics of said primary webpage.

20. The system of claim 15, wherein said evaluating said relevance data for said relevance correspondence includes evaluating based on the results of a cluster analysis.
